(19) United States
(12) Patent Application Publication
(10) Pub. No.: US 2008/0044554 A1
(43) Pub. Date: Feb. 21, 2008

(54) METHOD AND DEVICE FOR FINISHING AN ENDLESS FABRIC

(76) Inventors: Kerstin Lohr, Krefeld (DE); Bernhard Funger, Krefeld (DE); Andreas Piechowiak, Krefeld (DE)

Correspondence Address: KENYON & KENYON LLP, ONE BROADWAY, NEW YORK, NY, 10004, US

(21) Appl. No.: 11/836,475

(22) Filed: Aug. 9, 2007

(30) Foreign Application Priority Data
Aug. 15, 2006 (DE) 10 2006 038 339.7

(51) Int. Cl. D06C 27/00; B05D 1/28

(52) U.S. Cl. 427/10; 427/9; 68/13 R

(57) ABSTRACT

In a method and a device for finishing an endless fabric, the endless fabric is transported past a rotating applicator roll that is wetted with a liquor, in order to apply the liquor onto the endless fabric. On the endless fabric that has been transported onwards, after drying, the thread add-on, or its change, is measured and evaluated on an ongoing basis by a sensor, in order to regulate the rotational speed of the application roll as a function of the measuring result. A device is suitable for implementing the method.

### CROSS-REFERENCE TO RELATED APPLICATIONS

The present application claims priority to Application No. 10 2006 038 339.7, filed in the Federal Republic of Germany on Aug. 15, 2006, which is expressly incorporated herein in its entirety by reference thereto.

### FIELD OF THE INVENTION

The present invention relates to a method and a device for finishing, e.g., chemically finishing, an endless fabric, e.g., a fabric that includes fibers or threads, such as a fabric that includes paper, a textile, a nonwoven fabric, fleece, etc.

### BACKGROUND INFORMATION

Chemical finishing methods include, for example: dyeing, printing, flame-retarding, bleaching, washing machine-resistant finishing, nanofinishing, stain protection finishing, UV blocker finishing, antistatic finishing, antibacterial finishing, ironing-free finishing, burnt-out finishing, repellent finishing or insecticide finishing. The finishing of an endless fabric includes, among other things, the application of the generally fluid chemical, the so-called liquor, to the endless fabric. The quantity of this chemical which, at the end of the finishing process, actually has to be present on the endless fabric, especially on the fibers or threads after drying, so as to ensure the desired functionality of the product, is designated as thread add-on.

For the purpose of liquor coating, it is conventional to use applicators by which liquor is applied from a liquor reservoir to the endless fabric with the aid of an applicator roll. For this, the applicator roll can rotate in a liquor basin containing the liquor, the roll's surface being wetted by the liquor. The liquor is transferred to the endless fabric, which is moved along at the roll surface outside the liquor basin, by contact touch.

The quantity of liquor applied to the endless fabric per volume unit is also designated briefly as liquor coating.

The liquor coating depends on a plurality of parameters, such as the viscosity of the liquor, the angle of wrap at which the endless fabric lies against the applicator roll, the prerun speed of the endless fabric and the rotational speed of the applicator roll.

In order to obtain a constant functionality over the length of the endless fabric, the thread add-on has to be held as constant as possible. To do this, it is not sufficient to hold the liquor coating constant, since the thread add-on can vary even when the liquor coating is held constant, for instance, in response to changing the concentration of the finishing chemical in the liquor, changing the finishing behavior of the finishing chemical and/or the endless fabric in response to process temperature fluctuations, etc.

Therefore, in order to hold constant the properties of the endless fabric, all the parameters are adjusted to one another, mostly empirically, as a function of the material quality to be finished, and are held as constant as possible during the process. Monitoring the properties of the endless fabric is only possible by conducting spot checks, and mostly only by time-consuming analytical methods in the laboratory. Since the results of the analyses are only available offset in time, this leads to interruptions of the process that are disadvantageous and to the production of rejects in a not inconsiderable measure. A complete quality assurance cannot be achieved at all, using conventional methods.

### SUMMARY

Example embodiments of the present invention provide a method that avoids the above disadvantages and is therefore considered improved, for finishing an endless fabric and an associated device.

According to an example embodiment of the present invention, in a method for finishing an endless fabric, the endless fabric is conveyed past a rotating application roll wetted with a liquor, so as to apply the liquor on to the endless fabric, and so as to achieve finishing of the textile endless fabric. Finishing methods include, for example: dyeing, printing, flame-retarding, bleaching, washing machine resistant finishing, nanofinishing, stain protection finishing, UV blocker finishing, antistatic finishing, antibacterial finishing, ironing-free finishing, burnt-out finishing, repellent finishing and/or insecticide finishing. The endless fabric may be any fabric having fibers or threads, such as paper, textiles, a nonwoven fabric, etc.

In the endless fabric transported onwards, after drying, the thread add-on is continually measured and subsequently evaluated, for example, by an evaluation unit. The rotational speed of the roll is regulated if necessary, for example, by using a control unit, as a function of the measuring result, for example, by comparison with an empirically determined setpoint value.

It is believed that people have been of the opinion that holding constant the thread add-on can only be ensured if all the parameters influencing the thread add-on are strictly monitored and held at a constant level. It is also believed that people have been of the opinion that, especially in response to minimum application, deviations in one of the parameters cannot be compensated for, and certainly not continually during the finishing process, by the variation in another parameter.

An underlying tenet hereof is contrary to the foregoing viewpoint and relates to use a variation in the rotational speed of the applying roll to compensate for deviations in other parameters, such as liquor concentration, viscosity, endless fabric speed and angle of wrap, which lead to changes in the thread add-on. Regulation of the rotational speed of the applying roll is able to compensate for deviations in the thread add-on from a setpoint value and especially during minimum application, not only based on the large regulating range. An adjustment and the accurate monitoring of the other parameters, which are mostly connected with interruptions of the application method, may thus be omitted.

It is a further aspect hereof to perform the measurement of the affected parameter, and an adjustment possibly connected to that, on an ongoing basis. It is thereby possible to reduce the quantity of seconds produced and production costs in general, since the deviation can be held to a small tolerance window in time, during the continuous execution of the method.

Furthermore, the adjustment using the rotational speed of the applicator roll is also particularly suitable, since the rotational speed can be set in a particularly simple manner and at high regulating speed and regulating accuracy, without having to interrupt the production process.

Electrical properties of the endless fabric may be measured and evaluated, to achieve a reliable determination of the thread add-on.

The sensor may include a plate-type capacitor. During transport, the endless fabric runs through the field of the plate-type capacitor. The thread add-on can be measured using a method such as that described in German Published Patent Application No. 41 00 869, which is expressly incorporated herein in its entirety by reference thereto.

Such a method is distinguished by the comparatively rapid ascertainment of the change in the thread add-on. Using this method, the measurement and the evaluation of the thread add-on, or rather the change in it, can be carried out at particularly small time intervals, almost continuously, and particularly in a current manner. Rejects thus may be reduced or even prevented.

In response to a reduction in the thread add-on compared to a setpoint value, the rotational speed of the applying roll may be increased, and in response to an increase in the thickness of the thread add-on compared to a setpoint value, the rotational speed may be reduced. The setpoint value may be determined empirically, for example, for a specified textile quality.

According to an example embodiment of the present invention, a device, e.g., for carrying out the method, includes a roll configuration in which an endless fabric is transported past a rotating applicator roll that is wetted with a liquor, for the purpose of applying the liquor onto the endless fabric. The device includes a sensor situated in the transporting direction of the endless fabric, following the application, in order to measure the thread add-on or its change after the drying of the endless fabric. An evaluation unit and a control unit are further provided, to regulate, i.e., adjust the rotational speed of the applicator roll, as a function of the measuring result, for example, by comparison with a setpoint value. As mentioned above, because of the measuring of the thread add-on, and a regulation of the rotational speed of the applicator roll taking place as a function of this measurement, not only can a continuous, and thus a reject-reducing, quality assurance be provided, but also other parameters have to be monitored less accurately, or their fluctuations may be compensated for without additional intervention in the method.

The sensor may include a plate-type capacitor, the endless fabric being transported by the electrical field generated by the plate-type capacitor. Because of that, the measurement may be made in a contactless manner.

The roll configuration may include an applicator roll by which liquor is applied to the endless fabric from a reservoir. To do this, the applicator roll may be positioned partially dipped into the liquor tank.

According to an example embodiment of the present invention, a method for finishing an endless fabric includes: transporting the endless fabric past a rotating applicator roll that is wetted with a liquor to apply the liquor onto the textile endless fabric; measuring and evaluating a thread add-on a dry endless fabric in an ongoing manner on the endless fabric that has been transported onward; and regulating a rotational speed of the applicator roll as a function of a result of the evaluation.

The measuring and evaluating may include measuring and evaluating on an on-going basis an effect of the endless fabric on electrical properties of a capacitor to measure the thread add-on.

The method may include comparing the result of the evaluation to an empirically ascertained setpoint value that represents a desired thread add-on, and the regulating may include influencing the rotational speed of the applicator roll by actual value/setpoint value matching.

The capacitor may be arranged as a plate-type capacitor supplied with a periodic supply signal having a specified signal shape, the method may include scanning a modification of a response signal connected with a change in the thread add-on during at least one signal period at least one discrete point in time, and at least one discrete scanned value may be used in the evaluation.

The regulating may include increasing the rotational speed in response to a decrease in the thread add-on compared to a setpoint value and reducing the rotational speed in response to an increase in the thread add-on compared to the setpoint value.

According to an example embodiment of the present invention, a device includes: a roll configuration having a rotatable applicator roll wettable with a liquor; a transportation device configured to transport an endless fabric past the applicator roll to apply the liquor onto the endless fabric; a drier configured to dry the endless fabric; a sensor, arranged after the drier in a direction of transportation, configured to measure a thread add-on; and an evaluation and control unit configured to regulate a rotational speed of the applicator roll as a function of a measurement of the thread add-on.

The sensor may include a plate-type capacitor configured to generate an electrical field, past which the endless fabric is transportable.

The device may configured to perform the method described herein.

According to an example embodiment of the present invention, a device includes: roll means having rotatable applicator roll means wettable with a liquor; transporting means for transporting an endless fabric past the applicator roll means for applying the liquor onto the endless fabric; drying means for drying the endless fabric; sensing means, arranged after the drier means in a direction of transportation, for measuring a thread add-on; and evaluating and controlling means for regulating a rotational speed of the applicator roll means as a function of a measurement of the thread add-on.

Additional features, details and aspects of example embodiments of the present invention are described in more detail below with reference to the appended Figures.

### BRIEF DESCRIPTION OF THE DRAWINGS

FIG. 1 is a schematic view illustrating a method sequence according to an example embodiment of the present invention.

### DETAILED DESCRIPTION

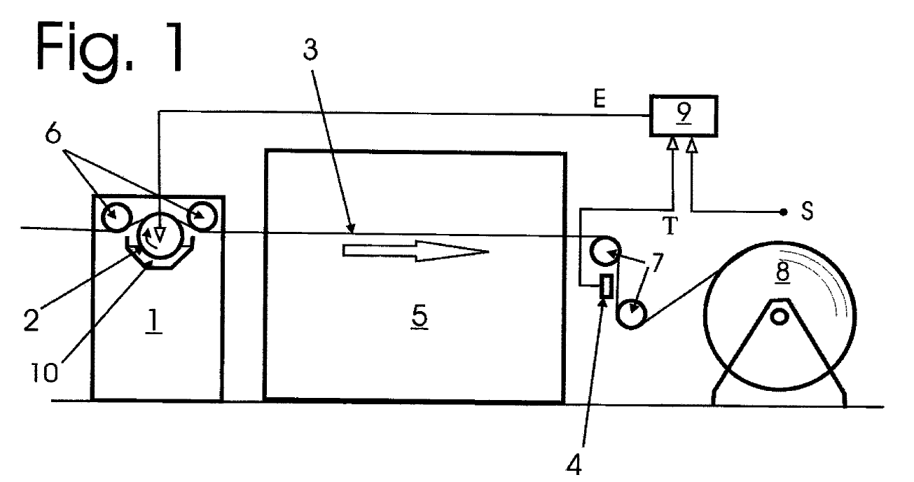

As illustrated in FIG. 1, an endless fabric 3 is transported in the direction of the arrow, which is drawn in only in outline. Textile endless fabric 3 may, for example, be brought in directly from a production method. Using roll configuration 1, the application of liquor takes place using a rotating applicator roll 2 that is partially dipped in a liquor tank and is thus continually wetted by liquor 10. To enlarge the contact surface between the surface of applicator roll 2 and textile endless fabric 3 that is transported past it while touching it, endless fabric 3 is partially diverted around application roll 2, using two guide rolls 6. The rotational speed of applicator roll 2 may be a significant variable for the application of the liquor, so that the thread add-on ensuing after the drying of the endless fabric may be particularly well regulated by varying the rotational speed of application roll 2. After the application, textile endless fabric 3 is conveyed through a drier 5. After drying, the thread add-on is measured in a contactless manner, using a sensor 4, on endless fabric 3 that is guided vertically past sensor 4, using two diversion rolls 7. The vertical alignment of endless fabric 3 and the sensor, in the vertical conveying section of the endless fabric, provides that no covering in dust occurs on the sensor surface, which could impair the measurement. The result of the measurement is transmitted as an actual value T to control and regulation unit 9. The control and regulation unit 9 compares actual value T to an empirically ascertained setpoint value S. The rotational speed of applicator roll 2 is regulated as a function of the deviation of actual value T from setpoint value S, using a manipulated variable E. The measurement of the thread add-on by sensor 4 takes place on an ongoing basis, e.g., continuously. After the measurement, textile endless fabric 3 is conveyed onwards for further processing, storage or for transportation to a wind up roll 8.

### LIST OF REFERENCE CHARACTERS

1 roll configuration
2 applicator roll
3 textile endless fabric
4 sensor
5 drier
6 guide rolls of the kissroll applicator
7 diversion rolls
8 wind up roll
9 control and evaluation unit
T actual value
S setpoint value
E setting value

What is claimed is:

1. A method for finishing an endless fabric, comprising:
transporting the endless fabric past a rotating applicator roll that is wetted with a liquor to apply the liquor onto the textile endless fabric;
measuring and evaluating a thread add-on a dry endless fabric in an ongoing manner on the endless fabric that has been transported onward; and
regulating a rotational speed of the applicator roll as a function of a result of the evaluation.

2. The method according to claim 1, wherein the measuring and evaluating includes measuring and evaluating on an on-going basis an effect of the endless fabric on electrical properties of a capacitor to measure the thread add-on.

3. The method according to claim 1, further comprising comparing the result of the evaluation to an empirically ascertained setpoint value that represents a desired thread add-on;
wherein the regulating includes influencing the rotational speed of the applicator roll by actual value/setpoint value matching.

4. The method according to claim 2, wherein the capacitor is arranged as a plate-type capacitor supplied with a periodic supply signal having a specified signal shape, the method further comprising scanning a modification of a response signal connected with a change in the thread add-on during at least one signal period at least one discrete point in time, at least one discrete scanned value being used in the evaluation.

5. The method according to claim 1, wherein the regulating includes increasing the rotational speed in response to a decrease in the thread add-on compared to a setpoint value and reducing the rotational speed in response to an increase in the thread add-on compared to the setpoint value.

6. A device, comprising:
a roll configuration having a rotatable applicator roll wettable with a liquor;
a transportation device configured to transport an endless fabric past the applicator roll to apply the liquor onto the endless fabric;
a drier configured to dry the endless fabric;
a sensor, arranged after the drier in a direction of transportation, configured to measure a thread add-on; and
an evaluation and control unit configured to regulate a rotational speed of the applicator roll as a function of a measurement of the thread add-on.

7. The device according to claim 6, wherein the sensor includes a plate-type capacitor configured to generate an electrical field, past which the endless fabric is transportable.

8. The device according to claim 6, wherein the device is configured to perform the method according to claim 1.

9. A device, comprising:
roll means having rotatable applicator roll means wettable with a liquor;
transporting means for transporting an endless fabric past the applicator roll means for applying the liquor onto the endless fabric;
drying means for drying the endless fabric;
sensing means, arranged after the drier means in a direction of transportation, for measuring a thread add-on; and
evaluating and controlling means for regulating a rotational speed of the applicator roll means as a function of a measurement of the thread add-on.
